(19) United States
(12) Patent Application Publication
(10) Pub. No.: US 2012/0318056 A1
(43) Pub. Date: Dec. 20, 2012

(54) VIBRATION DETECTION APPARATUS, AIR PRESSURE DETECTION TERMINAL, AND ACCELERATION DETECTION SYSTEM

(75) Inventors: Makoto IZUMI, (US); Naoteru Matsubara, (US)

(73) Assignee: SANYO ELECTRIC CO., LTD.

(21) Appl. No.: 13/594,367

(22) Filed: Aug. 24, 2012

Related U.S. Application Data
(63) Continuation of application No. PCT/JP2011/057139, filed on Mar. 24, 2011.

(30) Foreign Application Priority Data
Mar. 25, 2010 (JP) 2010-69183 (P)
Dec. 16, 2010 (JP) 2010-280908 (P)

(51) Int. Cl. B60C 23/02; G01H 17/00; G01P 1/07; G01P 15/10

(52) U.S. Cl. 73/146.3; 73/514.29; 377/19; 377/23

(57) ABSTRACT

A vibration detection apparatus includes a vibrating device that generates an alternating voltage by vibration; a power storage part that stores power based on the alternating voltage generated by the vibrating device; and a counter circuit that counts the number of vibrations of the alternating voltage generated by the vibrating device.

This application claims priority under 35 U.S.C. Section 119 of Japanese Patent Application No. 2010-069183 filed Mar. 25, 2010, entitled “VIBRATION DETECTION APPARATUS, ACCELERATION CALCULATION APPARATUS, AND ACCELERATION SENSOR” and Japanese Patent Application No. 2010-280908 filed Dec. 16, 2010, entitled “VIBRATION DETECTION APPARATUS, AIR PRESSURE DETECTION TERMINAL, AND ACCELERATION DETECTION SYSTEM”. The disclosures of the above applications are incorporated herein by reference.

### BACKGROUND OF THE INVENTION

1. Technical Field of the Invention

The present invention relates to a vibration detection apparatus using a vibrating device generating an alternating voltage by vibration, an air pressure detection terminal using the vibration detection apparatus, and an acceleration detection system.

2. Disclosure of the Invention

Architectural structures such as bridges and buildings, and plant machinery, may cause serious accidents including collapse when they are dilapidated. Accordingly, some measures for prevention of such accidents have been conventionally taken by attaching vibration detection apparatuses to architectural structures and the like so as to detect and control vibration of the same. If batteries are used to supply power to the vibration detection apparatuses, the batteries need to be replaced on a regular basis. Thus, there is suggested a vibration detection apparatus in which a vibration sensor and a power generator are combined to eliminate the need for replacement of batteries.

However, providing a power generator separately from a vibration sensor as in the foregoing case, makes it difficult to reduce the size of the vibration detection apparatus.

### SUMMARY OF THE INVENTION

A first aspect of the present invention relates to a vibration detection apparatus. The vibration detection apparatus according to the present invention includes: a vibrating device that generates an alternating voltage by vibration; a power storage part that stores power based on the alternating voltage generated by the vibrating device; and a counter circuit that counts the number of vibrations of the alternating voltage generated by the vibrating device.

A second aspect of the present invention relates to an air pressure detection terminal. The air pressure detection terminal according to the present invention includes: the vibration detection apparatus according to the first aspect; an air pressure detection part that detects an air pressure of a tire; an air pressure transmission part that transmits information on the air pressure detected by the air pressure detection part to an external device; and a control part. In this arrangement, the control part controls at least activation of the air pressure detection part, based on the number of vibrations counted by the counter circuit. The power storage part provides the stored power for use at the vibration detection apparatus, the air pressure detection part, the air pressure transmission part, and the control part.

A third aspect of the present invention relates to an acceleration detection system. The acceleration detection system according to the present invention includes: a vibrating device that generates an alternating voltage by vibration; a power storage part that stores power based on the alternating voltage generated by the vibrating device; a counter circuit that counts the number of vibrations of the alternating voltage generated by the vibrating device; and an arithmetic circuit that determines an acceleration based on the number of vibrations counted by the counter circuit.

### BRIEF DESCRIPTION OF THE DRAWINGS

These and other objects, and novel features of the present invention will become more apparent upon reading the following detailed description of the embodiment along with the accompanying drawings.

FIG. 1 is a block diagram showing a configuration of a vibration detection system according to a first embodiment;

FIG. 2A is a diagram showing a configuration of a substrate of a vibrating power generator according to the first embodiment and FIG. 2B is a diagram showing a configuration of the vibrating power generator;

FIG. 3A is a diagram showing a graph indicating output voltages and the number of vibrations of the vibrating power generator according to the first embodiment and FIG. 3B is a diagram schematically showing one vibration of the vibrating power generator;

FIG. 4 is a diagram showing an operating table stored in a memory circuit according to the first embodiment;

FIGS. 5A and 5B are flowcharts showing a method for calculation of an acceleration according to example 1;

FIG. 6 is a flowchart showing a method for calculation of an acceleration according to example 2;

FIG. 7 is a flowchart showing a method for calculation of an acceleration according to example 3;

FIG. 8 is a block diagram showing a configuration of a vibration detection system according to a second embodiment;

FIGS. 9A and 9B are flowcharts showing a method for calculation for an acceleration according to the second embodiment;

FIG. 10 is a block diagram showing a configuration of a vibration detection apparatus according to third embodiment;

FIG. 11 is a block diagram showing a configuration of a vibration detection apparatus according to a fourth embodiment;

FIG. 12 is a block diagram showing configurations of a vibration detection apparatus and a sensor terminal according to a modification example;

FIG. 13 is a flowchart showing a control operation performed by the sensor terminal according to the modification example; and

FIG. 14 is a block diagram showing a configuration of a sensor terminal according to another modification example.

However, the drawings are intended only for illustration, but do not limit the scope of the present invention.

### DESCRIPTION OF PREFERRED EMBODIMENTS

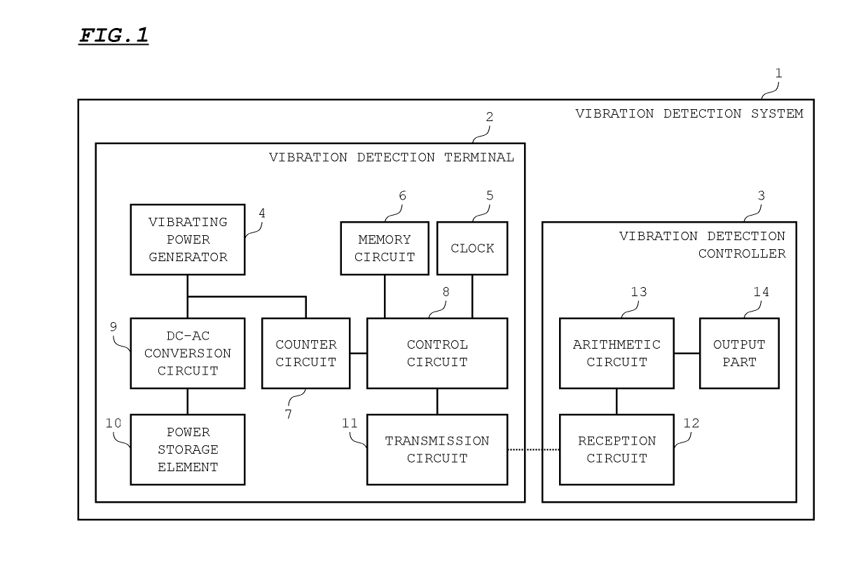

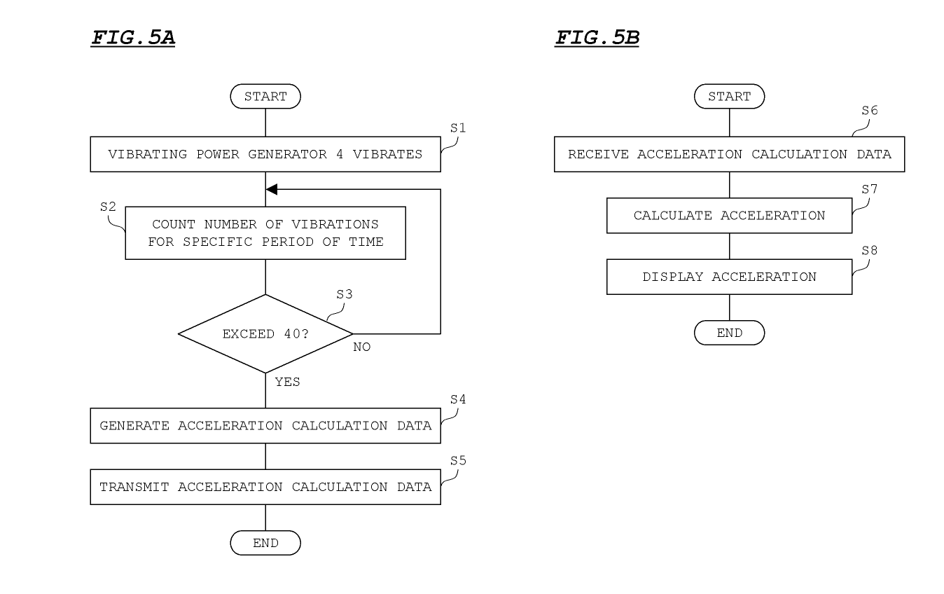

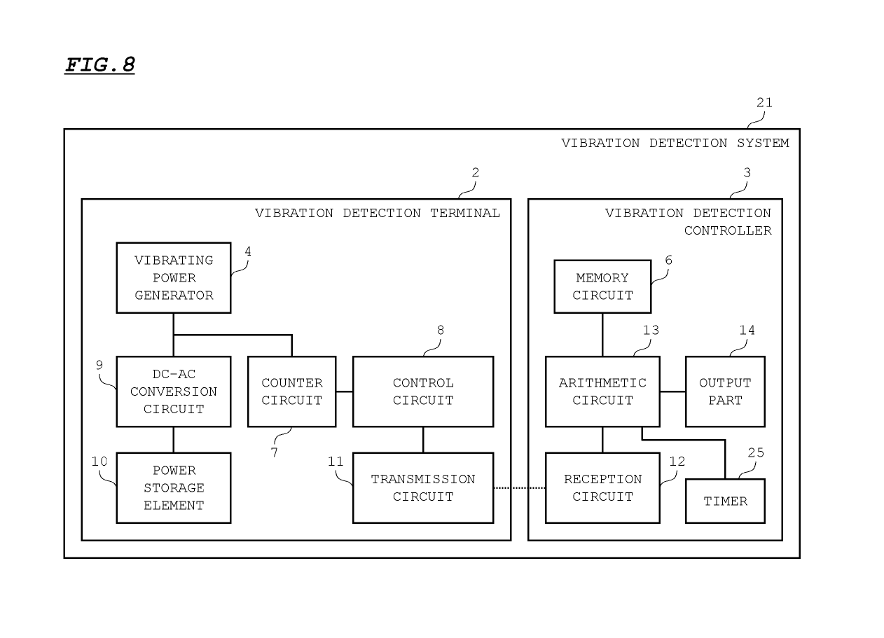

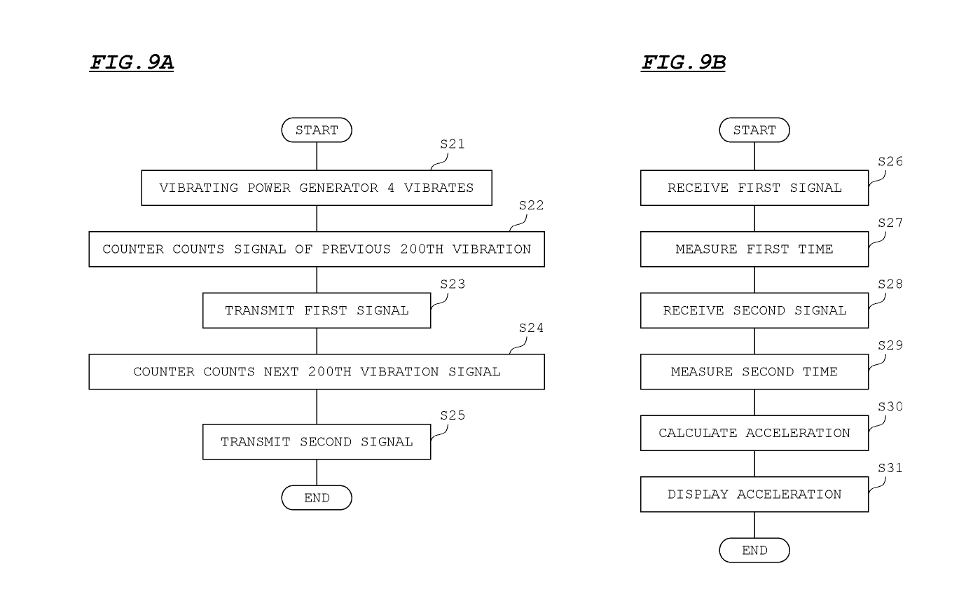

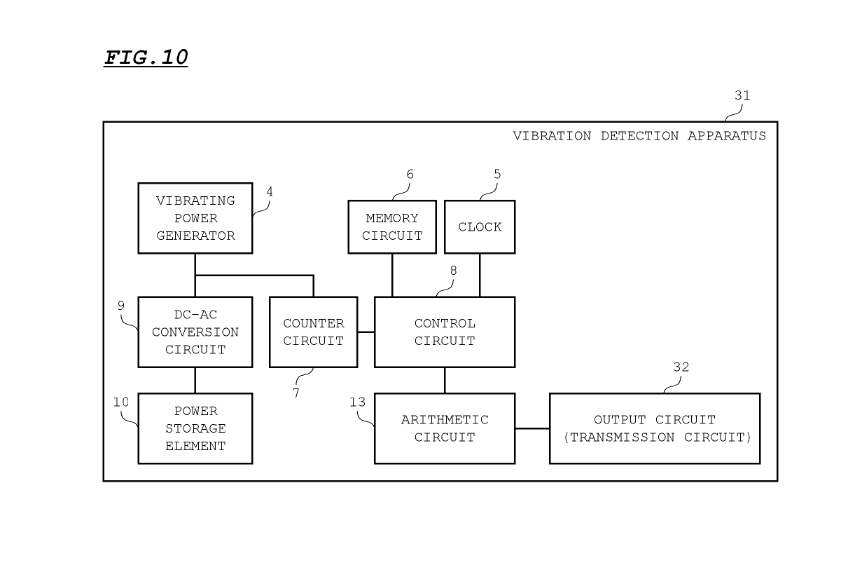

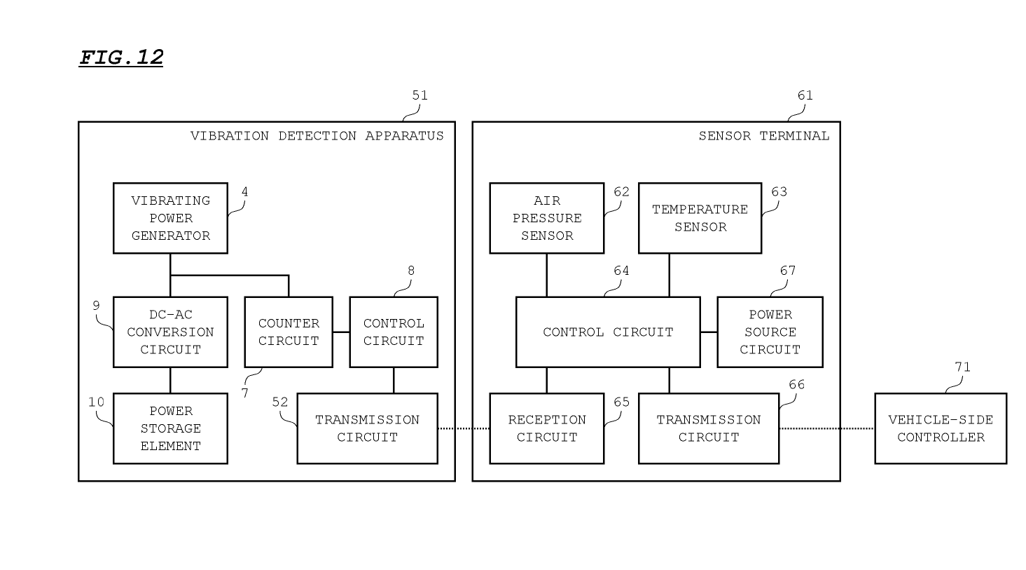

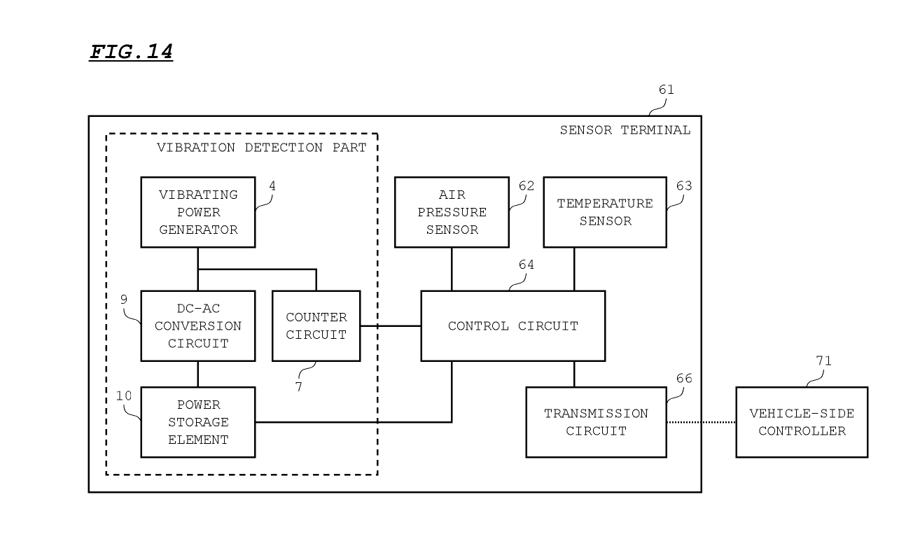

In embodiments described below, a vibrating power generator 4 corresponds to a “vibrating device” recited in Claims 1, 8, and 10; a DC-AC conversion circuit 9 and a power storage element 10 correspond to a “power storage part” recited in Claims 1, 8, and 10; and a counter circuit 7 corresponds to a “counter circuit” recited in Claims 1, 8, and 10. A control circuit 8 shown in FIGS. 1, 8, and 10 corresponds to an “information generation part” recited in Claim 3 and a “control part” recited in Claim 4; and a transmission circuit 11 shown in FIGS. 1 and 8 and an output circuit 32 shown in FIG. 10 correspond to a “transmission part” recited in Claim 4. An arithmetic circuit 13 shown in FIG. 10 also corresponds to the “information generation part” recited in Claim 3. A vibration detection apparatus 51 shown in FIG. 12 and a vibration detection part shown in FIG. 14 correspond to a “vibration detection apparatus” recited in Claim 8. An air pressure sensor 62, a control circuit 64, and a transmission circuit 66 shown in FIGS. 12 and 14 correspond to an “air pressure detection part,” a “control part,” and an “air pressure transmission part,” respectively, recited in Claim 8. A process shown in a flowchart of FIG. 5A corresponds to a process performed by the control part recited in Claim 5; and a process shown in a flowchart of FIG. 9A corresponds to a process performed by the control part recited in Claim 6. The foregoing correspondences between recitation in the claims and description of embodiments are merely examples, and do not intend to limit the claims to the embodiments.

### First Embodiment

A configuration of a vibration detection system 1 according to a first embodiment of the present invention will be described with reference to FIGS. 1 to 4.

<Configuration of the Vibration Detection System>

FIG. 1 is a block diagram for describing a configuration of the vibration detection system 1.

The vibration detection system 1 is formed by a vibration detection terminal 2 and a vibration detection controller 3. The vibration detection terminal 2 includes a vibrating power generator 4, a clock 5, a memory circuit 6, a counter circuit 7, a control circuit 8, a DC-AC conversion circuit 9, a power storage element 10, and a transmission circuit 11. The vibration detection controller 3 includes a reception circuit 12, an arithmetic circuit 13, and an output part 14.

The vibration detection system 1 measures the number of vibrations of the vibrating power generator 4 and a period of time taken for the vibrations, by the vibration detection terminal 2. The vibration detection system 1 also calculates an acceleration of the vibrating power generator 4 by the vibration detection controller 3, based on the number of vibrations of the vibrating power generator 4 and the time taken for the vibrations measured by the vibration detection terminal 2. In this arrangement, the vibration detection terminal 2 operates with power generated by the vibrating power generator 4. The vibration detection controller 3 operates with externally supplied power.

The vibration detection system 1 is preferably used for the cases where vibrations of architectural structures such as bridges and buildings or plant machinery are detected and managed. For example, the vibration detection terminal 2 is attached to architectural structures or the like, and the vibration detection controller 3 is provided in a computer for management.

The vibrating power generator 4 is configured to convert vibrational energy to electric power, and preferably uses an electrostatic-induction power generator.

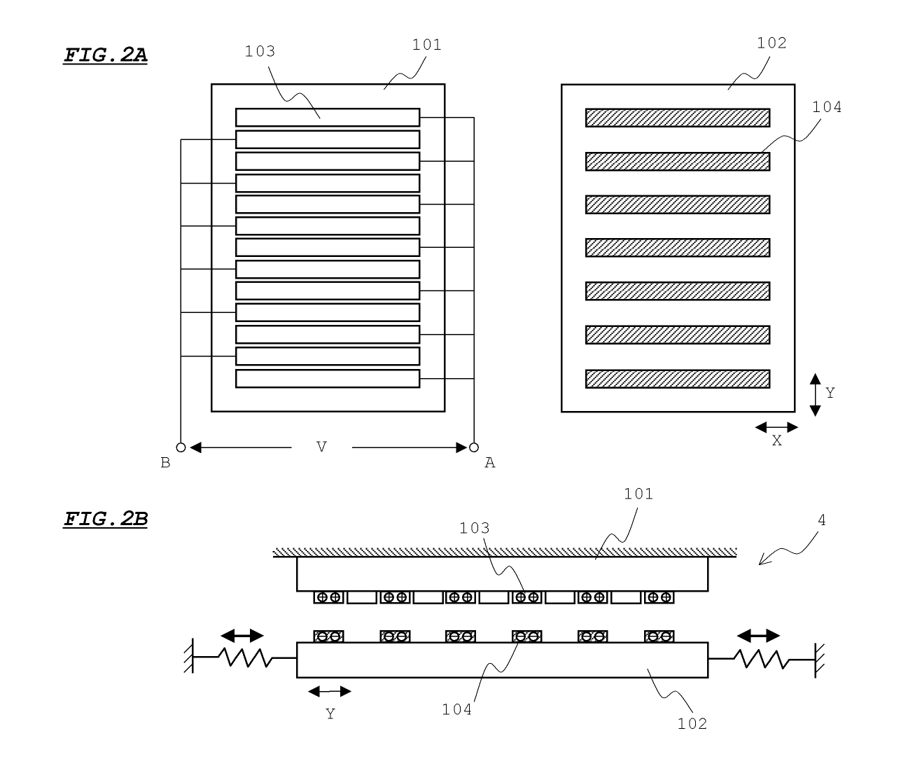

FIG. 2A is a diagram showing a configuration of a substrate of the vibrating power generator 4, and FIG. 2B is a cross sectional view showing a configuration of the vibrating power generator 4.

The electrostatic-induction vibrating power generator 4 includes a fixed substrate 101, a movable substrate 102, collective electrodes 103, and electrets 104. The electrets 104 are configured to hold certain electric charge semi-permanently, and in this configuration example, the electrets 104 hold negative charge.

The fixed substrate 101 has on a surface thereof the plurality of strip collective electrodes 103 extending in an X direction and arranged in parallel along a Y direction. The movable substrate 102 has on a surface thereof the plurality of strip electrets 104 extending in the X direction and arranged in parallel in the Y direction.

The fixed substrate 101 and the movable substrate 102 are disposed such that the collective electrodes 103 and the electrets 104 are opposed to each other. In this configuration, the collective electrodes 103 are arranged so as to be alternately opposed to the electrets 104. That is, the pitch of the collective electrodes 103 along the Y direction is half the pitch of the electrets 104 along the Y direction. The collective electrodes 103 and the electrets 104 are approximately identical in width along the Y direction. As shown in FIG. 2A, the odd-numbered collective electrodes 103 from the top are electrically connected to a terminal A, and the even-numbered collective electrodes 103 from the top are electrically connected to a terminal B.

Since negative charge is accumulated in the electrets 104, positive charge is induced by electrostatic induction to the collective electrodes 103 opposed to the electrets 104. When the movable substrate 102 moves relative to the fixed substrate 101 in the Y direction, variations arise in amount of electric charge induced to the collective electrodes 103 by electrostatic induction. As a result, a potential difference occurs between the terminals A and B by the amount of variation in electric charge, thereby generating electric power.

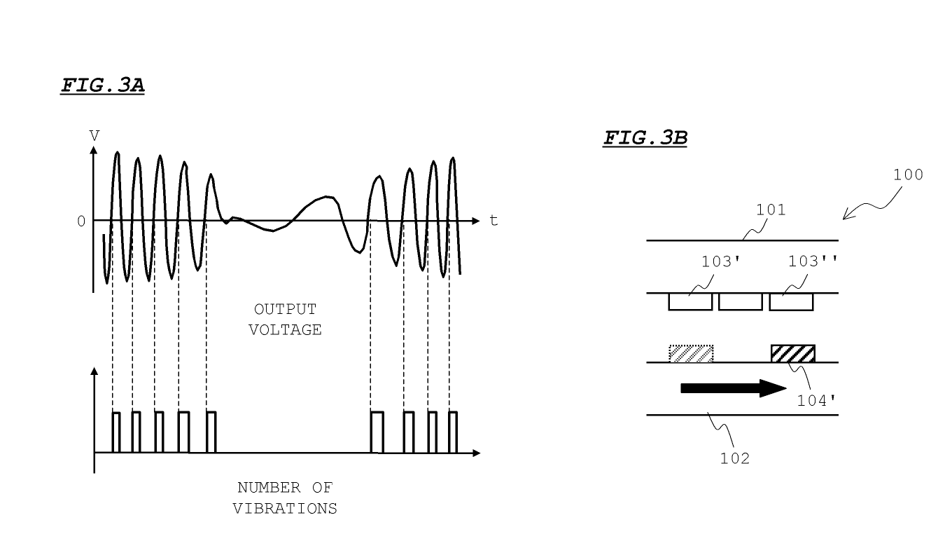

FIG. 3A is a graph showing output voltage and the number of vibrations of the vibrating power generator 4, and FIG. 3B is a diagram showing one vibration of the vibrating power generator 4.

At the vibrating power generator 4, the collective electrodes 103 are opposed to the electrets 104 to thereby generate a plus peak value in waveforms of output voltage, and the collective electrodes 103 are opposed to spaces between the electrets 104 to thereby generate a minus peak value of the same. In this embodiment, one vibration of the vibrating power generator 4 ranges from a plus (minus) peak value to the next plus (minus) peak value of output voltage. One vibration of the vibrating power generator 4 corresponds to movement of the movable substrate 102 with respect to the fixed substrate 101 during which an electret 104′ is opposed to a collective electrode 103′ and then is opposed to a next collective electrode 103″ but one, as shown in FIG. 3B.

The movable substrate 102 is supported by an elastic member such as a spring or a guide mechanism, so as to resonate in the Y direction at a constant frequency. Specifically, the movable substrate 102 resonates on vibration so as to reciprocate relative to the fixed substrate 101 by a fixed number of times per second. The more vigorously the movable substrate 102 vibrates, the larger the amplitude of the reciprocating motion of the movable substrate 102 becomes. Accordingly, when the movable substrate 102 vibrates vigorously, the voltage waveforms shown at the upper part of FIG. 3A become dense. Therefore, it is possible to detect the degree of vibration of the movable substrate 102 by counting the number of voltage waveforms per unit time, that is, the foregoing number of vibrations, thereby acquiring various parameters related to vibrations. For example, it is possible to extract an acceleration of vibration of the movable substrate 102 by counting the number of vibrations per unit time.

If it is assumed that a resonance frequency of the movable substrate 102 is designated as fo and the number of vibrations per unit time (the number of waveforms of output voltage) as Np, an acceleration a applied to the movable substrate 102 can be expressed as in the following equation:

α=k·Np (1)

where k denotes a proportionality factor for calculating the acceleration α from the number of vibrations Np, which is determined from the resonance frequency fo, a pitch P of the collective electrodes 103, and a weight M of the movable substrate 102.

In this embodiment, the vibrating power generator 4 is set as an electrostatic-induction power generator, but the present invention is not limited to this arrangement. For example, the vibrating power generator 4 may use an electromagnetic induction type.

Returning to FIG. 1, the clock 5 outputs a cyclic clock signal. According to the clock signal, the control circuit 8 measures a period of time. The clock 5 generally uses an oscillation circuit.

The memory circuit 6 stores an operation table for the control circuit 8 to control operations of the vibration detection terminal 2.

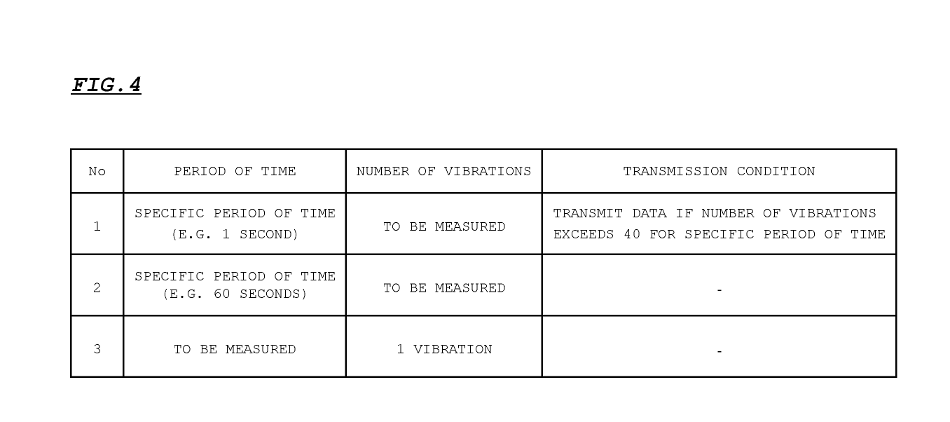

FIG. 4 is a diagram showing the operation table. The operation table includes associations of a period of time, the number of vibrations, and transmission condition. In No. 1 to 3 of the operation table, either the “period of time” or “number of vibrations” is to be measured. If the “number of vibrations” is to be measured, the “period of time” describes conditions for the measurement. If the “period of time” is to be measured, the “number of vibrations” describes conditions for the measurement. For example, in each of No. 1 and 2, the number of vibrations of output voltage from the vibrating power generator 4 for a specific period of time is to be measured. In No. 3, a period of time taken for one vibration of output voltage from the vibrating power generator 4 is to be measured.

The “transmission condition” here refers to a condition for transmitting the measured data to the vibration detection controller 3. For example, in No. 1 of the example of FIG. 4, the measured data is to be transmitted to the vibration detection controller 3 only if the number of vibrations measured for a specific period of time exceeds a predetermined number (40 in the example of FIG. 4). In No. 2 and 3, the measured data is to be transmitted to the vibration detection controller 3 with no condition.

Returning to FIG. 1, the counter circuit 7 counts the number of vibrations of output voltage from the vibrating power generator 4. As described above, one vibration of the vibrating power generator 4 corresponds to a period ranging from a plus (minus) peak to a next plus (minus) peak of output voltage, and thus the counter circuit 7 measures the number of plus (minus) peaks of output voltage.

According to any of No. 1 to 3 of the operation table stored in the memory circuit 6, the control circuit 8 measures the number of vibrations of the vibrating power generator 4 or a period of time taken for the vibrations, and generates data for calculation of acceleration. The control circuit 8 also controls the transmission circuit 11 to transmit the generated acceleration calculation data to the vibration detection controller 3. The acceleration calculation data here refers to data including association between the number of vibrations of the vibrating power generator 4 and the period of time taken for the vibrations.

Here, a control operation performed by the control circuit 8 in the case of employing No. 1 of the operation table, will be specifically described. First, the control circuit 8 references to No. 1 of the operation table from the memory circuit 6. In No. 1, a condition is set for the “period of time” and the “number of vibrations” is “to be measured.” Accordingly, the control circuit 8 measures the “number of vibrations” corresponding to a “specific period of time” set as a condition for the “period of time.” Specifically, the control circuit 8 measures the number of vibrations of the vibrating power generator 4 counted by the counter circuit 7 for a period of time according to a clock signal from the clock 5. However, the operation table defines a “transmission condition” as “data is to be transmitted if the number of vibrations for a period of time exceeds 40.” Accordingly, only if the number of vibrations of the vibrating power generator 4 exceeds 40 for a specific period of time, the control circuit 8 generates acceleration calculation data and transmits the same to the vibration detection controller 3.

The DC-AC conversion circuit 9 is a rectifier circuit to convert an alternating current generated by the vibrating power generator 4 into a direct current.

After the DC-AC conversion circuit 9 converts electric power generated by the vibrating power generator 4, the power storage element 10 stores the same. The power storage element 10 supplies power to individual constituent elements of the vibration detection terminal 2.

The transmission circuit 11, when receiving an instruction for transmission of acceleration calculation data from the control circuit 8, transmits the data to the vibration detection controller 3. The transmission circuit 11 preferably conducts wireless communications such as near field communications or ZigBee (registered trademark), for example.

The reception circuit 12 receives the acceleration calculation data transmitted from the transmission circuit 11 of the vibration detection terminal 2. The reception circuit 12 preferably performs wireless communications as with the transmission circuit 11.

The arithmetic circuit 13 calculates an acceleration of vibration of the vibrating power generator 4 according to the foregoing equation (1) based on the acceleration calculation data received by the reception circuit 12.

The output part 14 outputs results of calculation related to the vibrating power generator 4 performed by the arithmetic circuit 13. The output part 14 generally uses a display.

### Method for Calculation of an Acceleration

### Example 1

A method for calculation of an acceleration according to an example 1 of the vibration detection system 1 will be described with reference to FIGS. 5A and 5B. FIGS. 5A and 5B are flowcharts showing the method for calculation of an acceleration according to an example 1. FIG. 5A shows a process performed by the vibration detection terminal 2, and FIG. 5B shows a process performed by the vibration detection controller 3. In the example 1, the control circuit 8 performs a control operation according to No. 1 of the operation table shown in FIG. 4.

Referring to FIG. 5A, in the vibration detection terminal 2, when the vibrating power generator 4 vibrates (S1), the control circuit 8 counts the number of vibrations of the vibrating power generator 4 for a specific period of time by the counter circuit 7, using a clock signal obtained from the clock 5 (S2). Here, a specific period of time can be freely set by a user, and may be set to one second, for example. Next, the control circuit 8 determines whether the number of counts for a specific period of time exceeds 40 (S3). If the number of counts exceeds 40 (S3: YES), the control circuit 8 generates acceleration calculation data in which the number of vibrations of the vibrating power generator 4 counted by the counter circuit 7 is associated with a specific period of time defined in No. 1 of the operation table (S4). In contrast, if the number of counts does not exceed 40 (S3: NO), the process returns to S2. The control circuit 8 causes the transmission circuit 11 to transmit the generated acceleration calculation data to the vibration detection controller 3 (S5).

Referring to FIG. 5B, in the vibration detection controller 3, the reception circuit 12 receives the acceleration calculation data from the vibration detection terminal 2 (S6). The arithmetic circuit 13 calculates an acceleration of vibration of the vibrating power generator 4, from the period of time and the number of vibrations in the acceleration calculation data (S7). Specifically, the arithmetic circuit 13 calculates the number of vibrations Np per unit time from the period of time and the number of vibrations in the acceleration calculation data, and then determines an acceleration a according to the foregoing equation (1) based on the calculated number of vibrations Np. The output part 14 displays the acceleration output from the arithmetic circuit 13 (S8).

### Example 2

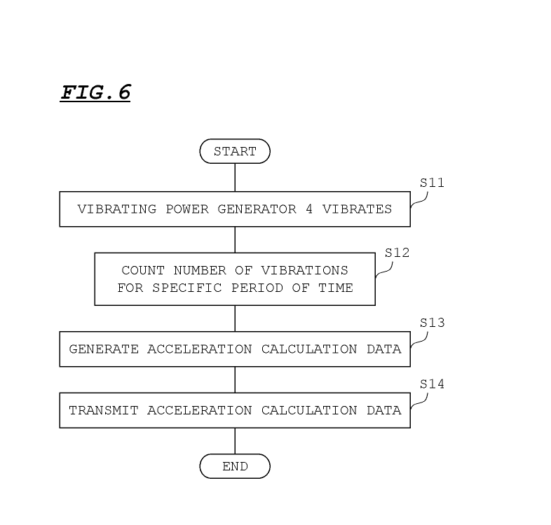

Next, a method for calculation of an acceleration according to an example 2 of the vibration detection system 1 will be described with reference to FIG. 6. FIG. 6 is a flowchart showing a method for calculation of an acceleration in the example 2. A process shown in the flowchart of FIG. 6 is performed by the vibration detection terminal 2. In the example 2, the control circuit 8 performs a control operation according to No. 2 of the operation table shown in FIG. 4.

In the vibration detection terminal 2, when the vibrating power generator 4 vibrates (S11), the control circuit 8 counts the number of vibrations of the vibrating power generator 4 for a specific period of time by the counter circuit 7, using a clock signal obtained from the clock 5 (S12). Here, a specific period of time can be freely set by a user, and may be set to 60 seconds, for example. The control circuit 8 generates acceleration calculation data in which the counted number of vibrations of the vibrating power generator 4 is associated with the specific period of time (S13). The control circuit 8 causes the transmission circuit 11 to transmit the generated acceleration calculation data to the vibration detection controller 3 (S14).

The vibration detection controller 3 determines an acceleration according to the foregoing equation (1) from the received acceleration data, and displays the determined acceleration, as in the example 1. A process performed by the vibration detection controller 3 is the same as that in the example 1, and thus a description on the process is omitted here.

### Example 3

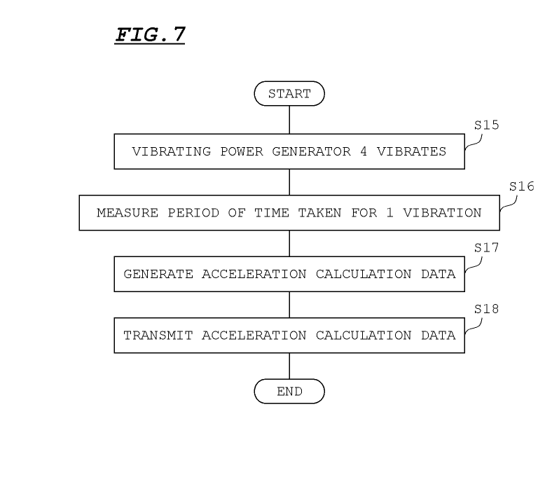

Next, a method for calculation of an acceleration according to an example 3 of the vibration detection system 1 will be described with reference to FIG. 7. FIG. 7 is a flowchart showing a method for calculation of an acceleration in the example 3. A process shown in the flowchart of FIG. 7 is performed by the vibration detection terminal 2. In the example 3, the control circuit 8 performs a control operation according to No. 3 of the operation table shown in FIG. 4.

In the vibration detection terminal 2, when the vibrating power generator 4 vibrates (S15), the control circuit 8 measures a period of time taken for one vibration of the vibrating power generator 4 counted by the counter circuit 7, based on a clock signal obtained from the clock 5 (S16). The control circuit 8 generates acceleration calculation data in which the number of vibration “1” and the period of time taken for the vibration are associated (S17). The control circuit 8 causes the transmission circuit 11 to transmit the generated acceleration calculation data to the vibration detection controller 3 (S18).

The vibration detection controller 3 determines an acceleration according to the foregoing equation (1) from the received acceleration data, and displays the determined acceleration, as in the example 1. A process performed by the vibration detection controller 3 is the same as that in the example 1, and thus a description on the same is omitted here.

Advantages of the vibration detection system 1 in this embodiment will be described below.

(1) The vibration detection system 1 calculates an acceleration of the vibrating power generator 4 based on the number of vibrations of output voltage from the vibrating power generator 4, and operates the individual constituent elements of the vibration detection terminal 2 with electric power generated by the vibrating power generator 4. Accordingly, it is possible to calculate an acceleration and generate electric power using output voltage from the vibrating power generator 4. This eliminates the need to provide the vibration detection terminal 2 with a separate power generator, and allows the vibrating power generator 4 to be used for both calculation of vibration-related information (acceleration) and power generation. Therefore, it is possible to reduce the parts count to thereby cut manufacturing costs for the apparatus and miniaturize the apparatus.

(2) If No. 1 shown in FIG. 4 is employed, the control circuit 8 of the vibration detection terminal 2 generates acceleration calculation data only if the number of vibrations counted by the counter circuit 7 for a specific period of time exceeds a predetermined number. Accordingly, the acceleration is to be calculated and displayed at the vibration detection system 1 only if an architectural structure or machinery becomes dilapidated and thus vibrates heavily. This makes it possible to give an alarm of heavy vibration more effectively and prevent collapse of the architectural structure or the like.

(3) When output power from the vibrating power generator 4 is stored, the amplitude of output voltage from the vibrating power generator 4 varies according to a change in amount of stored power in the power storage element 10. In the vibration detection system 1 according to this embodiment, vibration-related information (acceleration) is determined based on the number of vibrations of the vibrating power generator 4, not the amplitude of output voltage from the vibrating power generator 4. This makes it possible to acquire vibration-related information (acceleration) with high accuracy, regardless of the amount of stored power.

### Second Embodiment

Next, a vibration detection system 21 according to a second embodiment of the present invention will be described with reference to FIG. 8. FIG. 8 is a block diagram showing a configuration of the vibration detection system 21. Constituent elements of the second embodiment having the same functions as those of the first embodiment are given the same reference numerals, and thus descriptions on the same will be omitted here.

The vibration detection system 21 is formed by the vibration detection terminal 2 and the vibration detection controller 3. The vibration detection terminal 2 includes the vibrating power generator 4, the counter circuit 7, the control circuit 8, the DC-AC conversion circuit 9, the power storage element 10, and the transmission circuit 11. The vibration detection controller 3 includes the memory circuit 6, the reception circuit 12, the arithmetic circuit 13, the output part 14, and a timer 25.

The vibration detection system 21 is different from the vibration detection system 1 in the first embodiment, in that the vibration detection terminal 2 does not include the clock 5 and the memory circuit 6, and that the vibration detection controller 3 includes the memory circuit 6 and the timer 25. That is, the vibration detection system 21 includes the timer 25 in the vibration detection controller 3, instead of the clock 5 in the vibration detection terminal 2. Other arrangements of the second embodiment are identical to those of the first embodiment, and thus descriptions on the same will be omitted here.

Next, a method for calculation of an acceleration of the vibration detection system 21 will be described with reference to FIGS. 9A and 9B. FIGS. 9A and 9B are flowcharts showing the method for calculation of an acceleration. FIG. 9A shows a process performed by the vibration detection terminal 2, and FIG. 9B shows a process performed by the vibration detection controller 3.

Referring to FIG. 9A, in the vibration detection terminal 2, when the vibrating power generator 4 vibrates (S21), the control circuit 8 causes the counter circuit 7 to count the number of vibrations of the vibrating power generator 4 and causes the transmission circuit 11 to transmit a signal each time the counter circuit 7 counts 200 times. The signal is a trigger signal for calculation of an acceleration. Specifically, when the counter circuit 7 counts a previous 200th vibration (S22), the control circuit 8 causes the transmission circuit 11 to transmit a first signal to the vibration detection controller 3 (S23). Then, when the counter circuit 7 counts a next 200th vibration (S24), the control circuit 8 causes the transmission circuit 11 to transmit a second signal to the vibration detection controller 3 (S25).

Referring to FIG. 9B, in the vibration detection controller 3, when the reception circuit 12 receives the first signal from the vibration detection terminal 2 (S26), the arithmetic circuit 13 measures a first time by the timer 25 (S27), and stores the same in the memory circuit 6. Then, when the reception circuit 12 receives the second signal from the vibration detection terminal 2 (S28), the arithmetic circuit 13 measures a second time by the timer 25 (S29), and stores the same in the memory circuit 6.

The memory circuit 6 stores in advance the number of vibrations of the vibrating power generator 4 as “200”. The arithmetic circuit 13 acquires the number of vibrations of the vibrating power generator 4 and the first and second times obtained at S27 and S29 from the memory circuit 6. The arithmetic circuit 13 calculates an acceleration of vibration of the vibrating power generator 4 from the vibration count and a time difference between the first and second times (S30). Specifically, the arithmetic circuit 13 determines the number of vibrations Np per unit time based on the number of vibrations and the time difference, and calculates the acceleration of vibration according to the foregoing equation (1) based on the determined Np. The output part 14 outputs the acceleration of vibration calculated by the arithmetic circuit 13 (S31).

In addition to the advantages of the vibration detection system 1 of the first embodiment, the vibration detection system 21 of this embodiment provides the following advantage:

(4) The vibration detection system 21 includes the timer 25 in the vibration detection controller 3, instead of the clock in the vibration detection terminal 2. Not providing the clock 5 makes it possible to reduce power consumption at the vibration detection terminal 2 because the clock 5 consumes a larger amount of power as compared to other constituent elements of the vibration detection terminal 2. Therefore, at least the vibration detection terminal 2 can be driven with power generated by the vibrating power generator 4.

### Third Embodiment

Next, a vibration detection apparatus 31 according to a third embodiment of the present invention will be described with reference to FIG. 10. FIG. 10 is a block diagram showing a configuration of the vibration detection apparatus 31. Constituent elements of the third embodiment having the same functions as those of the first embodiment are given the same reference numerals, and thus descriptions on the same will be omitted here.

The vibration detection apparatus 31 includes the vibrating power generator 4, the clock 5, the memory circuit 6, the counter circuit 7, the control circuit 8, the DC-AC conversion circuit 9, the power storage element 10, and an output circuit (or transmission circuit) 32. Specifically, the vibration detection apparatus 31 is not divided into the vibration detection terminal 2 and the vibration detection controller 3 unlike in the first embodiment, but performs integrated functions of these components. Accordingly, as compared with the first embodiment, the vibration detection apparatus 31 does not have the reception circuit 12 and the output part 14.

The vibration detection apparatus 31 is attached to architectural structures or the like, for example, and is preferably used for the cases where vibrations are detected and managed by transmitting only calculated acceleration data from the output circuit (or transmission circuit) 32 to a management computer. Other configurations and operations of the third embodiment are identical to those of the first embodiment, and thus descriptions on the same will be omitted here.

In addition to the advantages of the vibration detection system 1 in the first embodiment, the vibration detection apparatus 31 of this embodiment has the following advantages.

(5) Acceleration of the vibrating power generator 4 can be calculated only by the vibration detection apparatus 31. This eliminates the need to provide a management computer with the arithmetic circuit 13 calculating an acceleration, thereby making it possible to manage acceleration data by the simple equipment.

### Fourth Embodiment

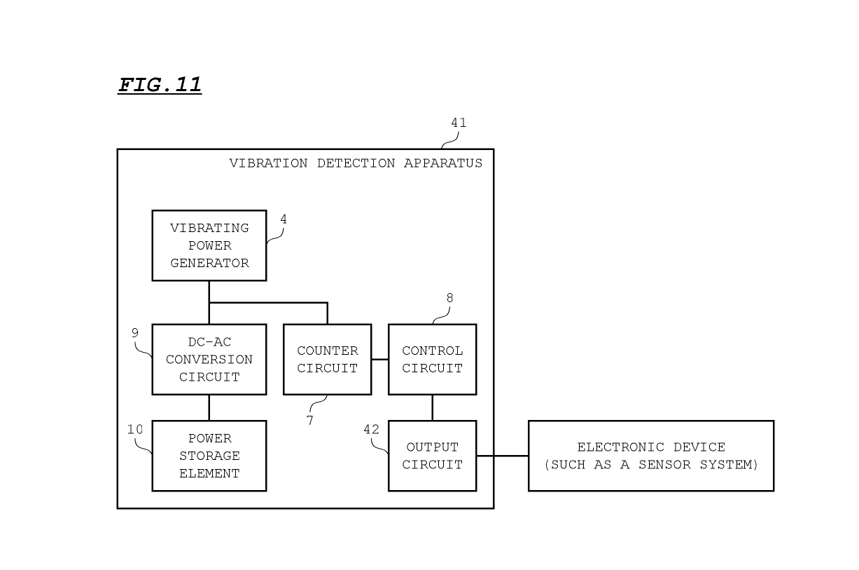

Next, a vibration detection apparatus 41 according to a fourth embodiment of the present invention will be described with reference to FIG. 11. FIG. 11 is a block diagram showing a configuration of the vibration detection apparatus 41. Constituent elements of the fourth embodiment having the same functions as those of the third embodiment are given the same reference numerals, and thus descriptions on the same will be omitted here.

The vibration detection apparatus 41 includes the vibrating power generator 4, the counter circuit 7, the control circuit 8, the DC-AC conversion circuit 9, and the power storage element 10, and an output circuit 42. As compared to the third embodiment, the vibration detection apparatus 41 does not have the memory circuit 6 and the clock 5 in the third embodiment, and outputs only data on the presence or absence of vibration. For example, the control circuit 8 monitors output from the counter circuit 7 as needed, and detects occurrence of vibration by increase in output from the counter circuit 7. Then, upon detection of occurrence of vibration, the control circuit 8 causes the output circuit 42 to output a signal indicative of the occurrence of vibration.

The vibration detection apparatus 41 is used in combination with another electronic device (e.g. a sensor system), and is attached to architectural structures or the like, for example. In this case, a signal from the output circuit is transmitted to the other electronic device. Upon detection of vibration by the vibration detection apparatus 41 as a trigger, the other electronic device (e.g. a sensor system) is activated to generate a predetermined event. Examples of such an event include: (1) transmitting unique ID information (alarm) to a management computer; (2) transmitting temperature information and time information to a management computer; (3) switching on a display; (4) switching on a light; (5) playing music, and the like. Alternatively, power from the power storage element 10 included in the vibration detection apparatus 41 can be supplied to the other electronic device.

As in the foregoing, configurations of the vibration detection systems and the vibration detection apparatuses in the first to fourth embodiments are described. However, the present invention is not limited to the foregoing configurations, and the embodiments of the present invention can be modified in various manners within the scope of the claims. Examples of modifications and advantages thereof will be described below.

In the vibration detection system 1 of the first embodiment, the conditions of No. 1 to 3 are stored in the operation table, but the operation table is not limited to this configuration. For example, the conditions “period of time,” “number of vibrations,” and “transmission condition” in the operation table may be set by a user as appropriate.

The vibration detection system 21 of the second embodiment is configured to transmit a signal to the vibration detection controller 3 each time the vibrating power generator 4 performs 200 vibrations, but the present invention is not limited to this configuration and the number of vibrations may be arbitrarily set by a user as appropriate.

In relation to the first to third embodiments, the methods for calculation of an acceleration of vibration of the vibration detection system and the vibration detection apparatus are described above, but the present invention is not limited to these methods. In the present invention, it is possible to determine, in addition to the acceleration of vibration, the presence or absence of vibration, the speed of vibration, and the amplitude of vibration. In this case, the speed of vibration can be calculated by integrating once acceleration data, and the amplitude of vibration can be calculated by integrating twice acceleration data.

### Applications of the Embodiments

Next, applications of the vibration detection system and the vibration detection apparatus described above in relation to the embodiments will be described.

For example, the vibration detection system can be applied to machine equipment at plants or the like. In this case, it is possible to manage a maintenance cycle for the machine equipment at a host computer via the vibration detection controller by detecting abnormal vibrations occurring typically just before breakdown of the machine equipment. As a result, performing maintenance on the machine equipment before breakdown makes it possible to reduce costs for repair of individual devices, and using power from the vibrating power generator makes it possible to save time and efforts for replacement of batteries, thereby decreasing total maintenance costs.

In addition, the vibration detection system can be applied to management tasks for monitoring safety of personnel in charge of hazardous work or elderly persons. In this case, workers in narrow manholes or the like or elderly persons living single wear vibration detection terminals, for example. Accordingly, if the vibration detection controller detects stoppage of vibration for a specific period of time, it is possible to take immediate measures such as making rescue efforts. In addition, the vibration detection system uses a vibrating power generator as a power source, which reduces malfunction due to battery exhaustion.

Further, the vibration detection system can be applied to a security system. In this case, a vibration detection terminal is attached to a door or the like, for example. If detecting any vibration, the vibration detection terminal performs comparison of IDs or the like, and transmits result of the comparison to the vibration detection controller. This makes it possible to recognize the presence of any intruder.

In addition, the vibration detection apparatus can be used in combination with a sensor terminal of a tire pressure monitoring system (TPMS). In this case, when a vehicle starts to move with rotation of tires, the vibration detection apparatus detects vibrations. The sensor terminal is activated or stopped depending on result of the detection of vibration, which reduces power consumption of the sensor terminal as compared to the case of using a sensor terminal constantly in the power-on state.

FIG. 12 is a diagram showing an example of a configuration of the vibration detection apparatus in combination with a sensor terminal in a TPMS.

In this configuration example, a vibration detection apparatus 51 is configured in the same manner as the vibration detection apparatus 41 of the fourth embodiment shown in FIG. 11. The vibration detection apparatus 51 includes the vibrating power generator 4, the counter circuit 7, the control circuit 8, the DC-AC conversion circuit 9, the power storage element 10, and a transmission circuit 52. Functions of the foregoing components are the same as those of the corresponding constituent elements of the vibration detection apparatus 41 shown in FIG. 11. The control circuit 8 monitors output from the counter circuit 7 as needed, and detects occurrence of vibration by increase in output from the counter circuit 7, and causes the transmission circuit 52 to output a signal (vibration signal) indicative of the occurrence of vibration. The vibration detection apparatus 51 is placed within a tire of an automobile so as to rotate with rotation of the tire.

A sensor terminal 61 includes an air pressure sensor 62, a temperature sensor 63, a control circuit 64, a reception circuit 65, a transmission circuit 66, and a power source circuit 67. As with the vibration detection apparatus 51, the sensor terminal 61 is also placed within a tire of an automobile so as to rotate with rotation of the tire.

The air pressure sensor 62 detects an air pressure within a tire. The temperature sensor 63 detects a temperature within the tire. The control circuit 64 controls components within the sensor terminal 61. The reception circuit 65 receives a signal transmitted from the transmission circuit 52 on the vibration detection apparatus 51 side. The transmission circuit 66 transmits information on the air pressure and the temperature detected by the air pressure sensor 62 and the temperature sensor 63 to a vehicle-side controller 71 under control of the control circuit 64. The power source circuit 67 includes a battery and supplies power stored in the battery to the individual components within the sensor terminal 61 under control of the control circuit 64.

The transmission circuit 52 of the vibration detection apparatus 51 and the reception circuit 65 of the sensor terminal 61 exchange signals in a wireless or wired manner. In addition, the transmission circuit 66 transmits information on the air pressure and the temperature to the vehicle-side controller 71 in a wireless manner.

The power source circuit 67 is switched by the control circuit 64 between two states: sleep state and active state. In the sleep state, the power source circuit 67 supplies power to the control circuit 64 and the reception circuit 65, and shuts down supply of power to circuits other than the control circuit 64 and the reception circuit 65. In the active state, the power source circuit 67 supplies power to all of the circuits within the sensor terminal 61.

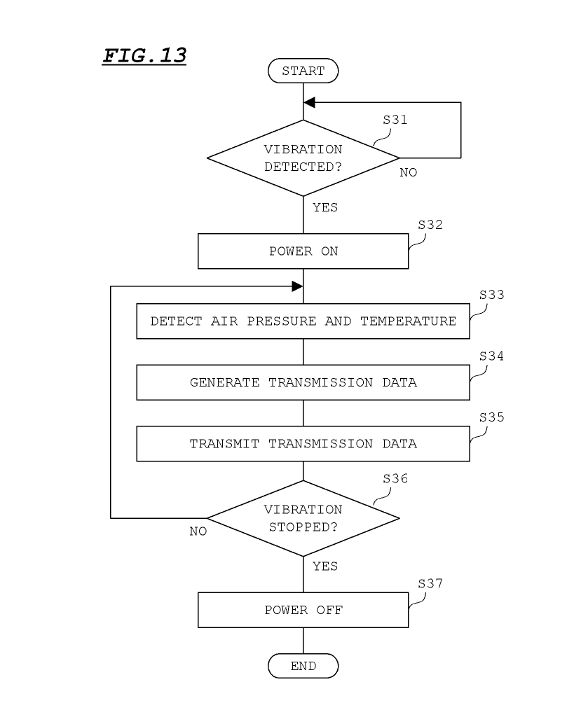

FIG. 13 is a flowchart showing a flow of a control process performed by the sensor terminal 61.

When the vehicle starts to run, the control circuit 64 of the sensor terminal 61 receives a vibration signal via the reception circuit 65 (S31: YES). In response to this, the control circuit 64 switches the power source circuit 67 from the sleep to active states (S32). Accordingly, power from the power source circuit 67 is supplied to all of the circuits within the sensor terminal 61. Subsequently, at a predetermined control timing, the control circuit 64 acquires detection values of air pressure and temperature from the air pressure sensor 62 and the temperature sensor 63 (S33), and generates information on air pressure and temperature (transmission data) from the acquired detection values (S34). Then, the control circuit 64 causes the transmission circuit 66 to transmit the generated transmission data (S35). The transmitted information on air pressure and temperature is received by the vehicle-side controller 71 for use in control over running of the vehicle.

After that, the control circuit 64 determines whether the transmission of a vibration signal from the vibration detection apparatus 51 is stopped, that is, whether the vehicle is stopped (S36). If the transmission of the vibration signal is not stopped (S36: NO), the control circuit 64 returns to S33 to execute processes on and after S33 at a next control timing. On the other hand, if the transmission of a vibration signal is stopped (S36: YES), the control circuit 64 switches the power source circuit 67 from the active state to sleep state (S37), thereby terminating the process. After that, the control circuit 64 waits for transmission of a vibration signal from the vibration detection apparatus 51 at S31.

According to this configuration example, the power source circuit 67 is set in the sleep state until the vehicle starts to move and the tires rotate, thereby to shut down power supply to circuits other than the control circuit 64 and the reception circuit 65. This makes it possible to reduce power consumption of the sensor terminal 61 as compared to the case where power is constantly supplied to the components. Accordingly, the lifetime of the battery within the power source circuit 67 can be lengthened.

In the configuration example of FIG. 12, the vibration detection apparatus 51 and the sensor terminal 61 are separated, but an arrangement for detection of vibration (vibration detection part) may be provided within the sensor terminal 61 as shown in FIG. 14. In this case, the vibration detection part is configured such that the control circuit 8 and the transmission circuit 52 are eliminated from the vibration detection apparatus 51 shown in FIG. 12, and the reception circuit 65 of the sensor terminal 61 is eliminated. In addition, the control circuit 64 of the sensor terminal 61 detects rotation of the tires by increase in count value of the counter circuit 7, and executes the control operation shown in FIG. 13.

In the configuration example of FIG. 14, the power source circuit 67 shown in FIG. 12 is eliminated and the circuits within the sensor terminal 61 are supplied with power from the power storage element 10. When the control circuit 64 is in the sleep state, the power storage element 10 supplies power to the counter circuit 7, the DC-AC conversion circuit 9, and the control circuit 64, and shuts down power supply to the circuits other than the foregoing ones. When the control circuit 64 is in the active state, the power storage element 10 supplies power to all of the circuits within the sensor terminal 61.

In the configuration example of FIG. 14, the circuits within the sensor terminal 61 are operated with power generated by the vibrating power generator 4, thereby eliminating the need for replacement of batteries. Accordingly, the sensor terminal 61 can be used semi-permanently.

In addition to the combination with a sensor terminal in a TPMS as described above, the vibration detection apparatus can also be applied to an automobile smart key or an entering/leaving management tag. These are collectively called active RF-ID, which has a wireless circuit in a constantly active state because it is necessary to constantly monitor ID information. This causes a problem that a cycle of battery replacement is relatively short. When the vibration detection apparatus is applied to the active RF-ID, it is possible to reduce power consumption by stopping the wireless circuit in the absence of vibration and activating the wireless circuit in the presence of vibration, thereby supporting a longer battery replacement cycle and unnecessity of battery replacement.

Besides, the embodiments of the present invention can be modified as appropriate in various manners within the scope of technical ideas recited in the claims.

What is claimed is:

1. A vibration detection apparatus comprising:
a vibrating device that generates an alternating voltage by vibration;
a power storage part that stores power based on the alternating voltage generated by the vibrating device; and
a counter circuit that counts the number of vibrations of the alternating voltage generated by the vibrating device.

2. The vibration detection apparatus according to claim 1, wherein
the vibrating device is an electrostatic induction device having a comb-shaped electret and a comb-shaped electrode formed so as to be opposed to the electret.

3. The vibration detection apparatus according to claim 1, further comprising an information generation part that generates information related to acceleration based on the number of vibrations counted by the counter circuit.

4. The vibration detection apparatus according to claim 3, further comprising:
a transmission part that transmits information to an external device; and
a control part that controls the transmission part, wherein
the control part transmits the information related to acceleration determined by the information generation part, via the transmission part.

5. The vibration detection apparatus according to claim 4, wherein
the control part causes the transmission part to transmit the information related to acceleration if the number of vibrations counted by the counter circuit for a predetermined period of time exceeds a predetermined number.

6. The vibration detection apparatus according to claim 4, wherein
the control part causes the transmission part to transmit a trigger signal indicative of the information related to acceleration, at a timing when the number of vibrations counted by the counter circuit reaches a predetermined number.

7. The vibration detection apparatus according to claim 4, wherein
the counter circuit, the information generation part, the control part, and the transmission part operate with power generated by the vibrating device.

8. An air pressure detection terminal comprising:
a vibration detection apparatus having a vibrating device that generates an alternating voltage by vibration, a power storage part that stores power based on the alternating voltage generated by the vibrating device, and a counter circuit that counts the number of vibrations of the alternating voltage generated by the vibrating device;
an air pressure detection part that detects an air pressure of a tire;
an air pressure transmission part that transmits information on the air pressure detected by the air pressure detection part to an external device; and
a control part, wherein
the control part controls at least activation of the air pressure detection part, based on the number of vibrations counted by the counter circuit.

9. The air pressure detection terminal according to claim 8, wherein
the power storage part supplies the stored power to the vibration detection apparatus, the air pressure detection part, the air pressure transmission part, and the control part.

10. An acceleration detection system comprising:
a vibrating device that generates an alternating voltage by vibration;
a power storage part that stores power based on the alternating voltage generated by the vibrating device;
a counter circuit that counts the number of vibrations of the alternating voltage generated by the vibrating device; and
an arithmetic circuit that determines an acceleration based on the number of vibrations counted by the counter circuit.
